(19) United States
(12) Patent Application Publication
(10) Pub. No.: US 2008/0093191 A1
(43) Pub. Date: Apr. 24, 2008

(54) Variable Speed Drive

(76) Inventors: Jose Furtado, Lausanne (CH); Albert Muller, Renens (CH)

Correspondence Address: NIXON & VANDERHYE, PC, 901 NORTH GLEBE ROAD, 11TH FLOOR, ARLINGTON, VA, 22203, US

(21) Appl. No.: 11/794,033

(22) PCT Filed: Dec. 23, 2005
(86) PCT No.: PCT/IB05/54394

§ 371 Date: Jul. 18, 2007

(30) Foreign Application Priority Data
Dec. 24, 2004 (CH) 02149/04

(51) Int. Cl. F16D 31/02

(52) U.S. Cl. 192/59

(57) ABSTRACT

The invention concerns a novel type of variable speed drive different from those of prior art in that it does not comprise any gear and in that the speed variations are continuous.

### FIELD OF THE INVENTION

The present invention falls in the field of mechanical systems allowing the rotation speed of an exit axis, referred to as secondary axis, to be varied with respect to the rotation speed of an entry engine or motor axis, referred to as primary axis.

### PRIOR ART

Mechanical systems, for example gearboxes, are known where the regulation of the rotation speed of a secondary axis with respect to a primary axis is achieved by means of gears. In such a case, for example for the gearbox of an automobile, the user can manually choose the ratio that best corresponds to his speed of travel. With a manual gearbox, each gear is manually selected by the driver, by disengaging the clutch in order to be able to change gear by means of a lever and by re-engaging the clutch so as to then be able to drive the vehicle with its engine. Although considered as perfectly normal today, these maneuvers take time and require a certain amount of concentration. Such maneuvers are also often difficult to execute by young drivers or by elderly people, a fact which can make their driving dangerous. Finally, the parts required to build gearboxes are rather complex and require servicing. The clutch is typically a consumable part that needs to be replaced periodically.

Also in the field of automobiles, automatic gearboxes are known that allow the actions of the driver to be simplified in that he no longer needs to think about the choice of a gear ratio. These automatic gearboxes either comprise a mechanism which automatically controls the clutch, which results in the gearbox architecture being the same as a manual gearbox, or else they contain a torque converter (hydraulic) that chooses the appropriate ratio. One drawback of such gearboxes is their fairly large size, in any case larger than conventional manual gearboxes, which makes them heavier, generally resulting in a higher fuel consumption.

In the prior art, continuous variation gearboxes also exist which use metal transmission drive belts mounted on two pulleys, one connected to the primary shaft, the other to the secondary shaft. Separating the two faces of the pulley modifies the diameter around which the drive belts pass. Thus, by acting on the relative diameters of the two pulleys, the ratios between the two shafts and hence the relative rotation speeds of the shafts can be continuously changed. One major drawback of this system is its fragility, especially as regards the transmission drive belts, which limits the power that it is capable of transmitting. For this reason, such gearboxes have only been used on automobiles of limited size.

### SUMMARY OF THE INVENTION

Accordingly, one aim of the invention is to improve the known systems.

More particularly, one aim of the invention is a simple system that can be easily used manually or automatically to vary the speed between two elements.

For this purpose, the present invention relates to a new type of variable speed drive which differs from the prior art notably in that it does not comprise gears.

The device according to the invention, when used as a gearbox, is designed to relieve the repetitive performances of the gear lever maneuver, whichever mechanism is used for controlling the gear setting (manual or automatic).

The device according to the invention preferably comprises pistons, inclined planes, orifices, a primary axis, a secondary axis and a sump housing designed to contain a liquid, preferably a lubricant.

Its construction is simple and low-cost.

More precisely, the device according to the invention, according to a first embodiment, comprises:

one primary axis end comprising two inclined planes disposed obliquely with respect to the main direction of the primary axis,

one secondary axis end disposed in the extension of the end of the primary axis,

a block of cylinders disposed around the end of the primary axis and between said incline planes, said block being rigidly attached to the secondary axis, each cylinder wall comprising at least one orifice connecting the inside of the cylinder with the outside,

an assembly of pistons disposed within said cylinders, in such a manner that the stroke of the pistons is limited by said inclined planes,

an annular element mounted in a sliding fashion around the block of cylinders in such a manner as to momentarily close off said orifices,

means for displacing said annular element along the block of cylinders in such a manner as to allow said orifices to be fully opened, or completely or partially closed off,

all the aforementioned elements being contained within a sump housing designed to contain a liquid, for example oil.

The device according to the invention may be used in various fields, in particular in the automobile industry. In this case, it notably offers the following advantages:

Continuous increase in speed until the vehicle has reached its maximum performance;

Clutch operation is not required;

There is no dead time, which results in an energy saving;

It has no gears;

It can be installed as an add-on to a standard gearbox, or be integrated into it;

It can be controlled manually or automatically, e.g. via an electronic processor operated from the steering wheel;

It may be used as a self-blocking differential bridge.

The device according to the invention has been designed with the goal of accommodating the driver both from a physical and mental standpoint in his gear-changing maneuvers, by allowing him to concentrate more on driving the vehicle instead of having to search, think and choose into which position the control lever, which is never in the same place, should be moved.

The present invention is not, strictly speaking, an automatic transmission gearbox, even though such a thing has been designed with the same purpose. In automatic transmission gearboxes, the hydraulic torque converters have the drawbacks of removing from the driver the ability to control the engine speed and the free choice of the ratio he wishes to engage, in addition to the high power demand and consumption at each start-up. Moreover, this type of automatic transmission cannot be adapted to a vehicle with a clutch and conventional mechanical gearbox.

An additional aim of the invention is to allow it to be simply and readily adapted to any vehicle with conventional gearbox and clutch, and to leave the driver with this ability to control the engine speed and this free choice of the gear ratio to be engaged, guaranteeing a greater precision in the use of the power of the engine and a greater flexibility in the gear changes, while at the same time conserving the natural existence of the engine braking.

Via this device, even when tired, the driver has no problem in deriving the maximum benefit from the available power by choosing the appropriate gear ratio, whereas he often does not bother to change gear with the conventional lever leaving the engine to struggle or run at a speed where the power usage is only 50%.

Variants can be provided according to the type of vehicle to be equipped, the desired degree of automation and the desired gear-change maneuvering process.

In aviation construction, the device according to the invention can be used as rotation speed reducer for the turbine with respect to the propellers, thus replacing the conventional noisy reducers with their chains and their gears. It may be seen as a kind of silent reducer.

In the industrial field generally, it can be used as a reducer for electric motors and/or as an accessory with multiple applications for improving and equipping conventional machines. Depending on the desired degree of automation and the process to be applied, it offers enhanced productive capacity.

The invention can also be used as a self-blocking differential mechanism, for example in a vehicle. By installing it on each transmission shaft of a wheel, the ratio between said shaft and the wheel can thus be acted on. If one of the wheels spins (a behavior conventionally measured via rotation sensors, for example of the system known as ABS system), the ratio can be reduced or even all transmission of torque suppressed to this wheel and the torque transferred onto another wheel (or other wheels in the case of a vehicle with 4-wheel drive or more).

The dimensions of the device according to the invention are always determined as a function of the power of the engine. Similarly, the viscosity of the liquid, for example oil, can be chosen depending on the application.

The control can be manual, via a simple lever acting on the annular element, or may make use of an assisted device. By way of non-limiting example, the assisted device can comprise an electric control (for example manual such as a potentiometer) placed on the steering wheel and associated with an actuator that acts on the annular element, either by an electric, pneumatic or even hydraulic control.

The device can operate:

with one or more pistons,

with a single, double or more con-rod system,

with one or more inclined planes,

by elliptical or eccentric rotation,

in an oil bath or other liquid.

### BRIEF DESCRIPTION OF THE FIGURES

The invention will be better understood hereinbelow by means of the description of non-limiting embodiments illustrated by a series of figures in which

FIG. 1 shows a schematic lateral cross-sectional view of the variable drive according to the invention.

FIG. 2 shows another cross-sectional view of the variable drive according to the invention.

FIGS. 3A and 3B show two views of the cylinder block.

FIGS. 4A and 4B show two views of the end of the secondary axis.

FIG. 5 shows a lateral view of the end of the primary axis.

FIG. 6 shows a cross-sectional view of an inclined plane of the primary axis.

FIG. 7 shows a lateral view of a piston.

FIG. 8 shows a lateral cross-sectional view of a blocking ring.

FIGS. 9A and 9B illustrate an example of flange of the variable drive.

FIGS. 10A and 10B illustrate the housing of the variable drive.

FIGS. 11A and 11B show two views of a part of the control of the variable drive.

FIG. 12 shows a layout drawing of the speed control.

FIG. 13 shows a lateral partial cross-sectional view of the control of the variable drive.

FIG. 14 shows a front view of the control lever of the variable drive.

FIGS. 15 to 24 are perspective views of the variable drive according to the invention.

FIG. 25 illustrates a second embodiment of the invention.

FIG. 26 illustrates a third embodiment of the invention.

FIG. 27 illustrates one variant of the third embodiment of the invention.

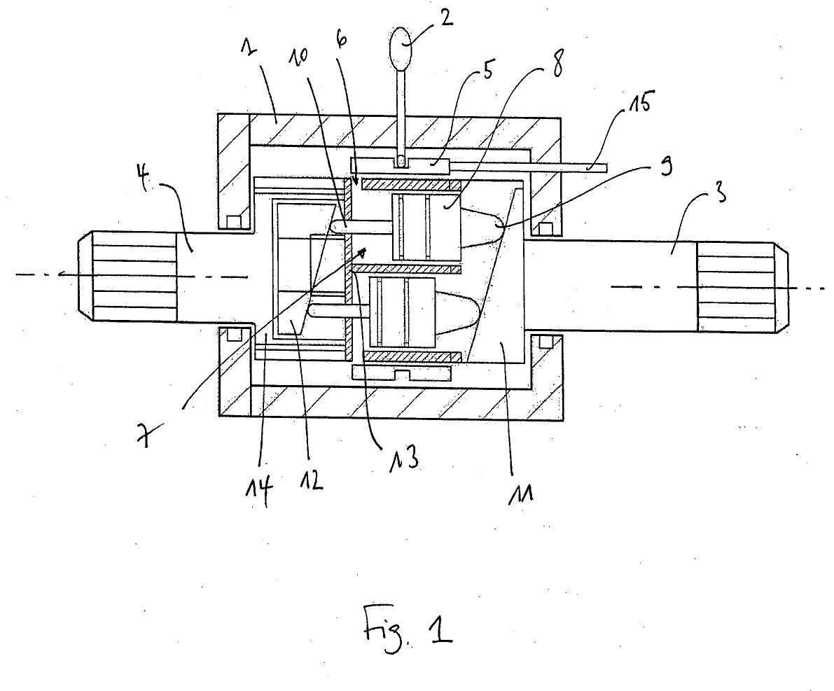

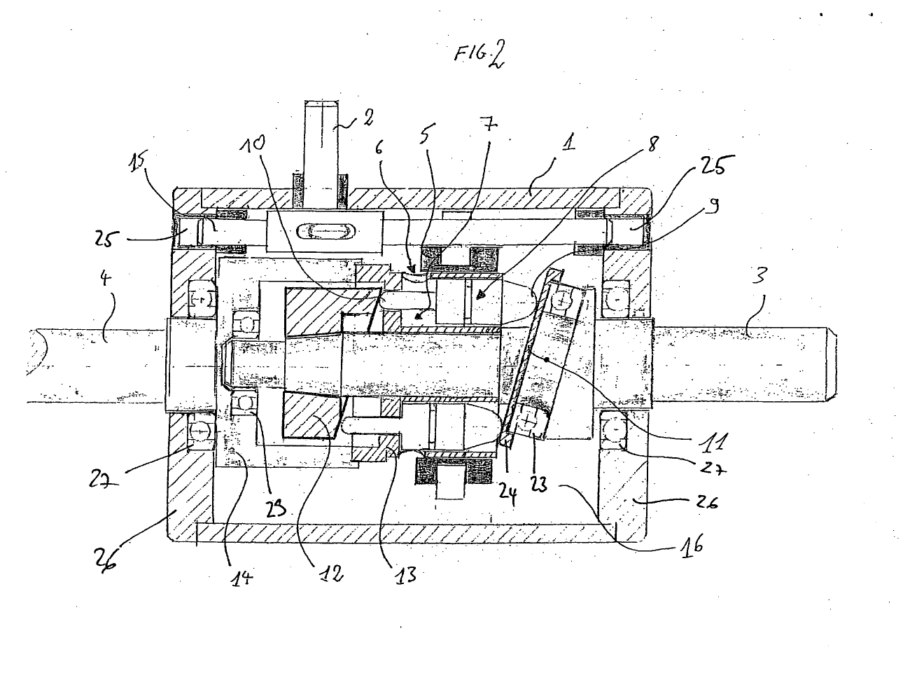

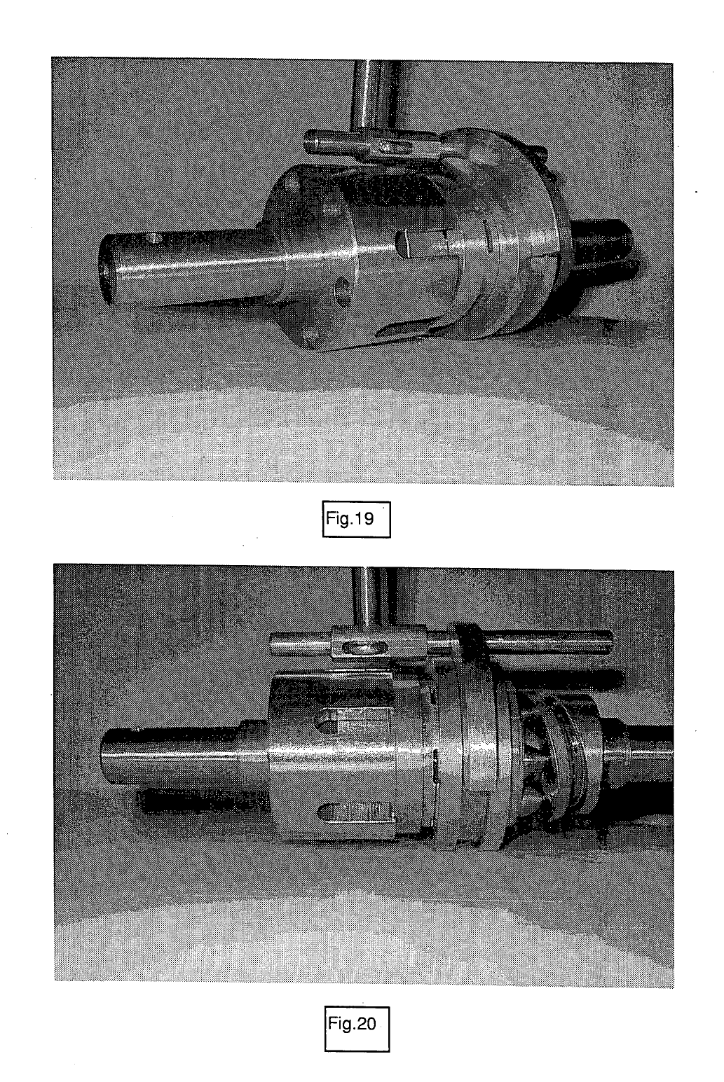

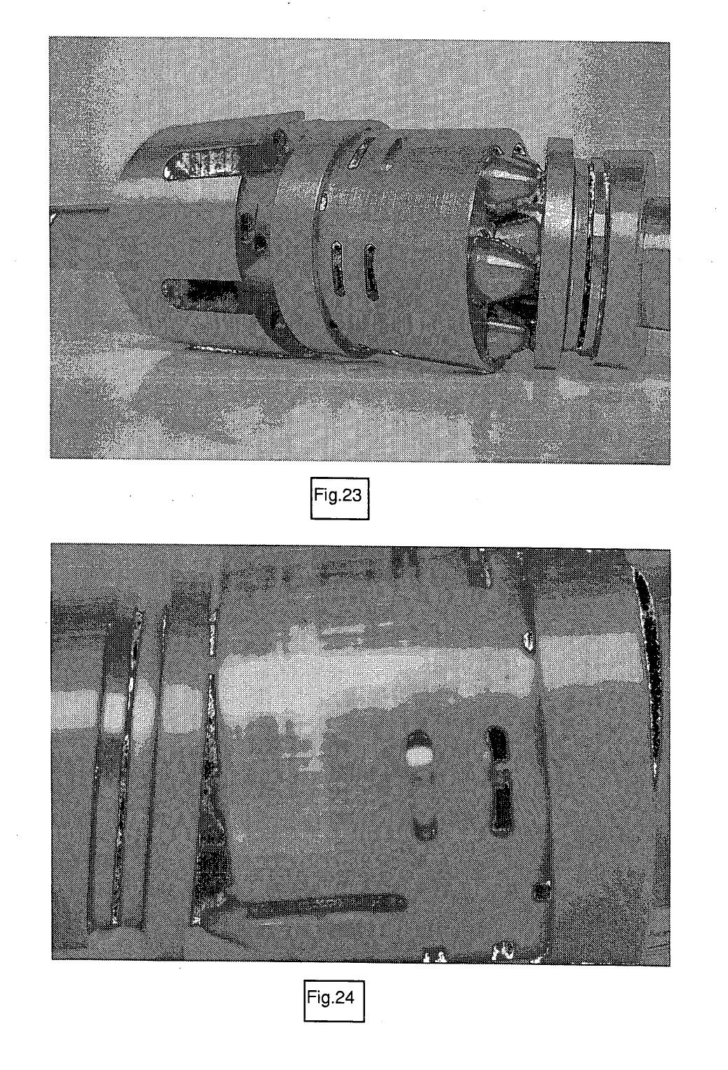

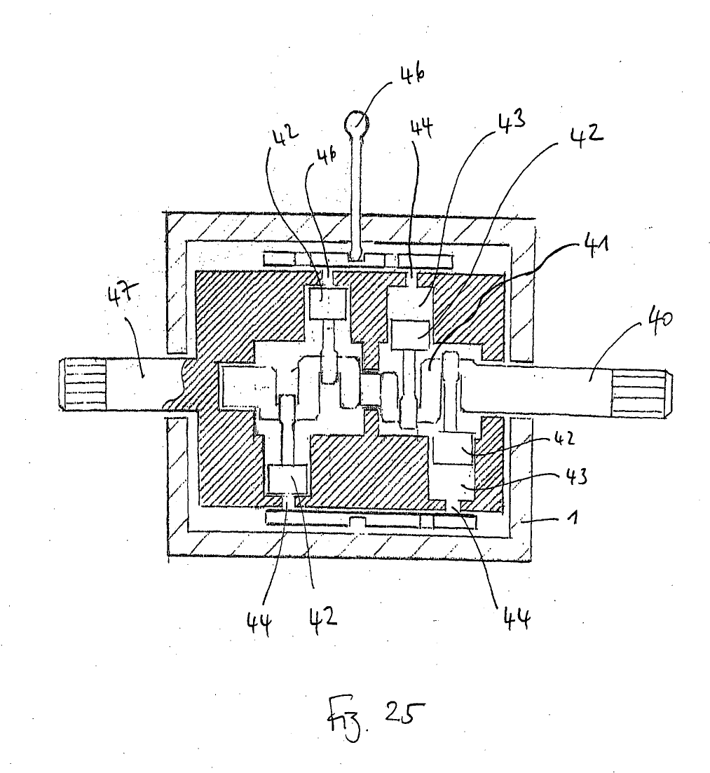

The first embodiment illustrated in FIG. 1 (simplified drawing) and FIGS. 2 to 24 comprises a housing 1 in which the end of a primary axis 3 is accommodated, the end of a secondary axis 4 situated in the extension of the primary axis 3 and a cylinder block 13 fixed at the end of the secondary axis 4.

The end of the primary axis 3 comprises a first inclined plane 11 and a second inclined plane 12.

The second inclined plane 12 is rigidly attached to the primary axis 3 by means of an assembly of orifices 21, 22 and of a rod (not shown) linking them.

Each cylinder of the block 13 comprises a chamber 7 within which a piston 8 moves. The first end of the piston 9 is located on the side of the first inclined plane 11 and the second end of the piston is located on the side of the second inclined plane 12.

Each chamber 7 is open to the sump housing 16 via one or two orifices 6, 18.

An annular element 5 is mounted so as to slide around the cylinder block 13. Its displacement is effected by actuating a handle 2 moving on a support 15.

Alternatively, the displacement of the annular element 5 may be effected under the control of an electronic processor (not shown).

Depending on the position of the annular element 5, the orifice or orifices 6, 7 are open, partially open or closed.

The sump housing 16 and the chambers 7 of the cylinder block 13 contain a liquid, e.g. oil.

The device operates as follows:

When the orifice or orifices 6, 18 of the cylinder block 13 are closed, the liquid present in the chambers 7 cannot get out of the cylinders. Since the liquid is incompressible, the pistons cannot move within the chambers 7. As a consequence, the assembly formed by the primary axis 3, the inclined planes 11, 12, the cylinder block 13 and the secondary axis 4 form a whole which is driven by the primary axis 3. In this case therefore, the rotation speed of the secondary axis 4 is identical to the rotation speed of the primary axis 3.

When the orifice or orifices 6, 18 of the cylinder block 13 are fully open, the liquid can flow freely between the chambers 7 of the cylinders and the chamber of the sump housing 16. The pistons 8 can therefore move freely within the chambers 7. During one rotation cycle of the primary axis 3, the pistons 8 perform a complete return stroke. As a consequence, the cylinder block 13 is no longer driven by the primary axis 3. In this case therefore, the rotation speed of the secondary axis is zero.

When the orifice or orifices 6, 18 of the cylinder block 13 are partially open, the liquid present in the chambers 7 of the cylinders still offers a certain resistance to the movement of the pistons 8. This resistance gets higher when the orifices are almost closed.

As a consequence, the cylinder block 13 is only partially driven by the primary axis 3. More precisely, just as soap slips between the hands, the first inclined plane 11 “slides” over the first ends 9 of the pistons 8.

Depending on the level of opening of the orifice or orifices 6, 18, the sliding is more or less accentuated.

In this case therefore, the rotation speed of the secondary axis 4 is lower (but not zero) than the rotation speed of the primary axis 3. The wider the opening of the orifice or orifices 6, 18, the lower the rotation speed of the secondary axis 4.

The variations in speed are therefore linear.

Expressed another way, the pistons are driven within the cylinders by means of the primary axis and the inclined planes. The latter have inclinations in proportion to the stroke of the pistons within the compression chambers, which determines the rotation speed of the drive action on the other axis. The variation in compression is determined in relation to the opening or the closing of the orifices of the cylinder chamber.

In FIG. 2, one variant of the first embodiment is shown with corresponding numerical references. In this variant, a ball bearing 23 and a plate 24 have been added onto the inclined plane 11. This allows the wearing by friction of the surface of the inclined plane 11 and of the first end of the pistons 9 to be reduced. Also in this variant, the handle support 15 can slide at its two ends within openings 25 located in each sealing flange 26 of the sump housing 1 containing the variable drive; bearings may be provided in these openings. Each of these flanges 26 carries a bearing 27 through which the primary shaft 3 and the secondary shaft 4 pass.

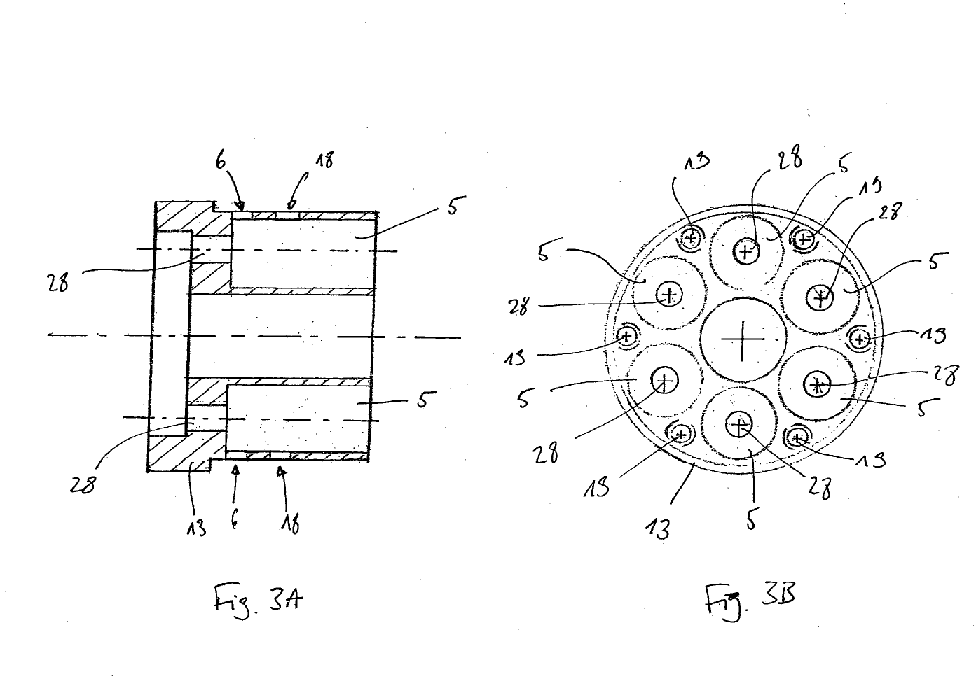

In FIGS. 3A and 3B, a cross-sectional and a front view of the cylinder block 13 are respectively shown. This block therefore comprises a series of cylinder chambers 5 (six in FIG. 3B) distributed around its axis. This number can of course be varied, in other words less than six chambers or more may be used. In this FIG. 3B can also be seen the threaded orifices 19 allowing the end 14 of the secondary axis 4 to be screwed onto the cylinder block 13.

In the cross section in FIG. 3A, each cylinder chamber 7 comprises two orifices 6 and 18 that allow the liquid to be evacuated according to the principles of operation described hereinabove. The invention can also operate with a single orifice per chamber or more than two. At the bottom end of the chambers 5, openings 28 are located that allow the passage of the second piston ends 10 (see also FIGS. 1 and 2) in which seals of the O-ring type (not shown) are provided to render it leak-proof.

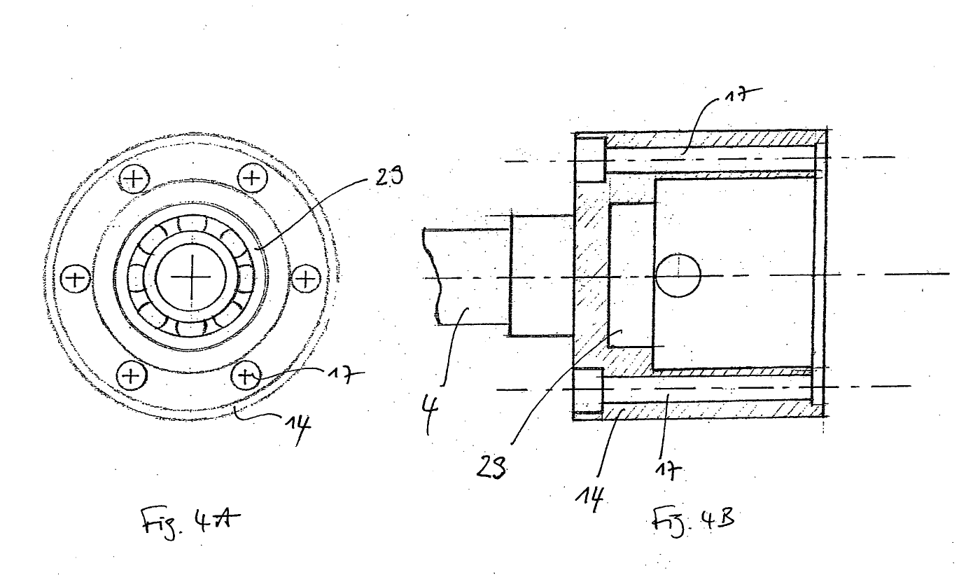

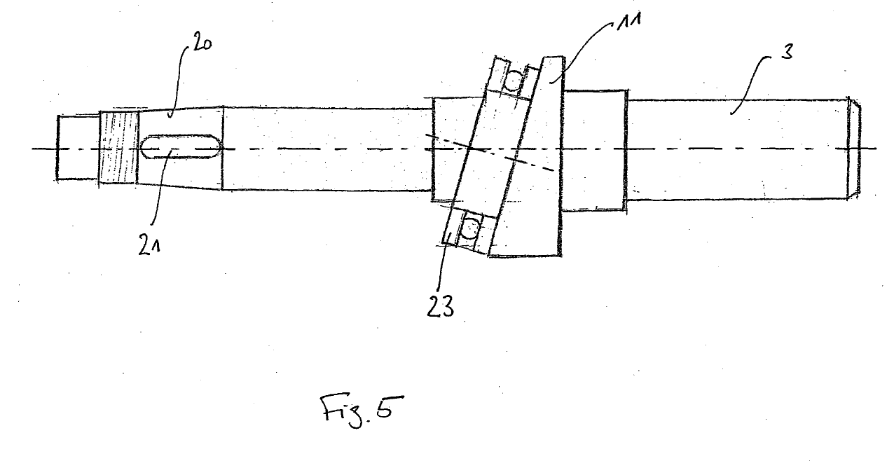

In FIGS. 4A and 4B, a front view (FIG. 4A) and a cross-sectional view (FIG. 4B) are shown of the end 14 of the secondary axis 4. This end 14 is formed from a sort of cage comprising several orifices 17 designed 35 to receive screws fixing this end to the cylinder block 13 (by the threads 19). A ball bearing 29, in which the end of the primary axis rests, is also preferably located in this cage.

In FIG. 5, a lateral view of the primary axis according to the invention is illustrated. At one end (on the right-hand side of the figure), this axis comprises for example a channeled part and then (going toward the left of the figure) an inclined plane 11. As indicated hereinbelow, a bearing 23 and a plate 24 are preferably added onto this plane 11 in order to reduce the wear on the piston ends 9 and on the inclined plane. At the other end, this axis ends in a contact region 20 between the axis and the second inclined plane 12 which is fixed to the axis 3 by a pin cooperating with an oblong hole 21.

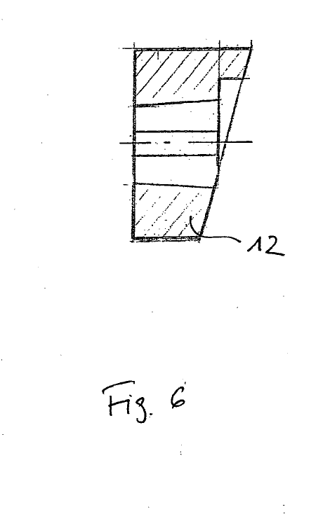

FIG. 6 shows an example of second inclined plane 12 designed to be installed on the primary axis 3 on the contact region 20 (see FIG. 5).

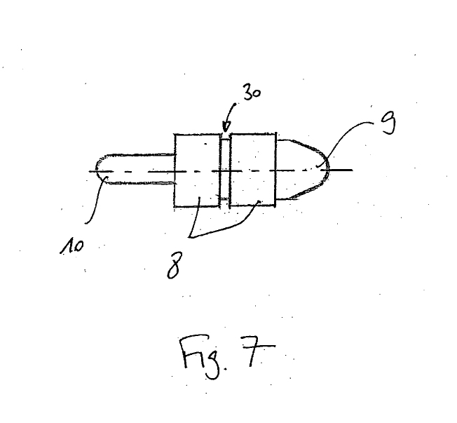

An exemplary embodiment of a piston 8 is illustrated in FIG. 7. This comprises a first end which is designed to come into contact with the inclined plane 11 or the plate 24, a body and a second end 10 which is designed to come into contact with the second inclined plane 12. In the central part of the body, at least one groove 30 is provided that is designed to receive a sealing means, for example an O-ring (not shown).

FIG. 8 shows a cross-sectional view of one embodiment of the blocking ring 5 for the orifices 1, 18. This ring notably comprises a groove 31 into which a control element is accommodated by which the displacement of said ring 5 is effected. An internal groove 32 may also be provided for accommodating a sealing means, such as an O-ring (not shown), within it.

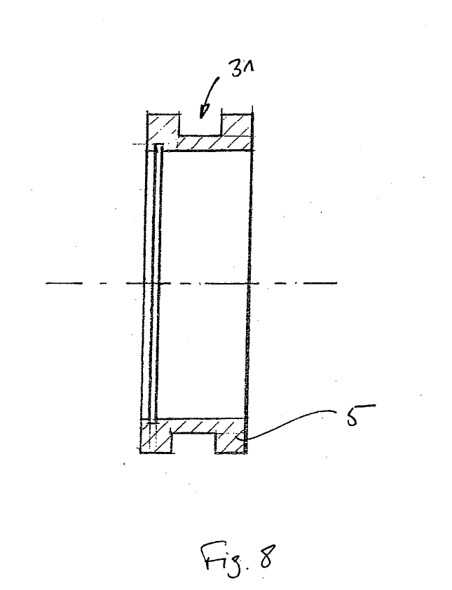

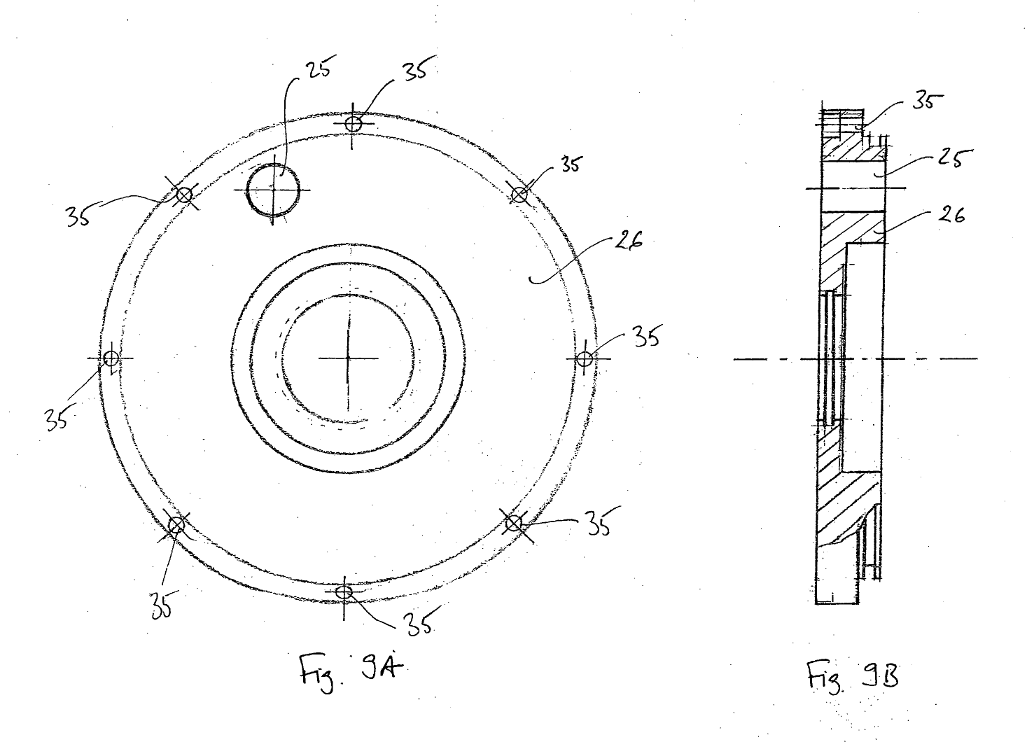

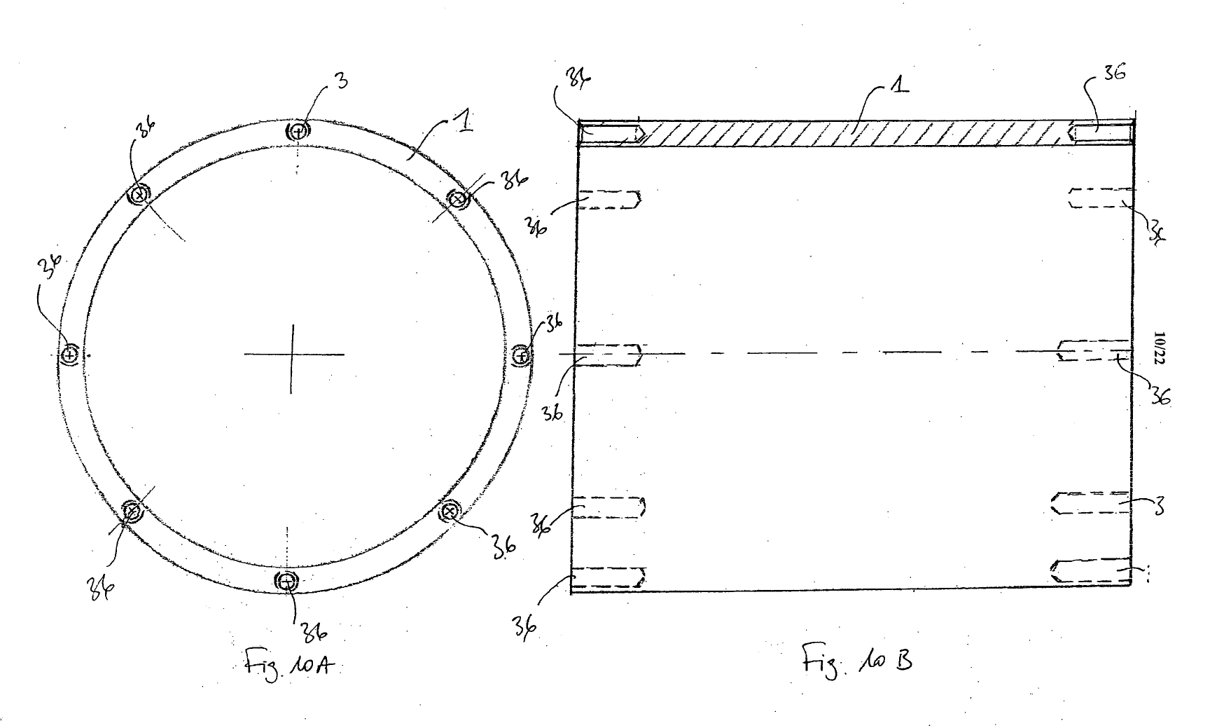

FIGS. 9A and 9B illustrate examples of flanges 26 allowing the housing 1 of the variable drive (see FIGS. 10A and 10B) to be closed. These flanges 26 comprise a series of holes 35 around their circumference which allow them to be fixed onto the housing by means of screws. The flanges also comprise an opening 25 for receiving the end of the handle support 15 (see FIG. 2 for example). The center of the flanges 26 is open and is able to receive a ball bearing 27, as shown in FIG. 2.

An example of housing 1 is shown in FIGS. 10A and 10B (front view in FIG. 10A and from the side in partial cross section in FIG. 10B). This housing 1 comprises a series of tapped holes 36 corresponding to the holes 35 in the flanges 26 for fixing them, with screws for example, onto the housing 1.

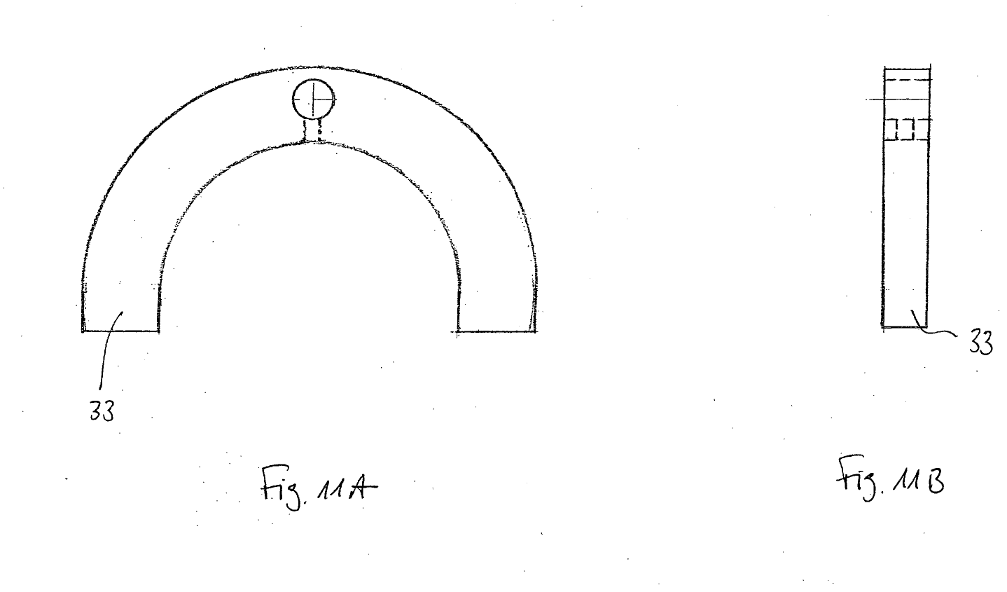

FIGS. 11A and 11B illustrate two views of an example of an actuating element 33 for the ring 5. This element 33 has the shape of a horse-shoe and is designed to slot into the groove 31 of the blocking ring 5. Means for fixing the element 33 to the ring 5 can be provided.

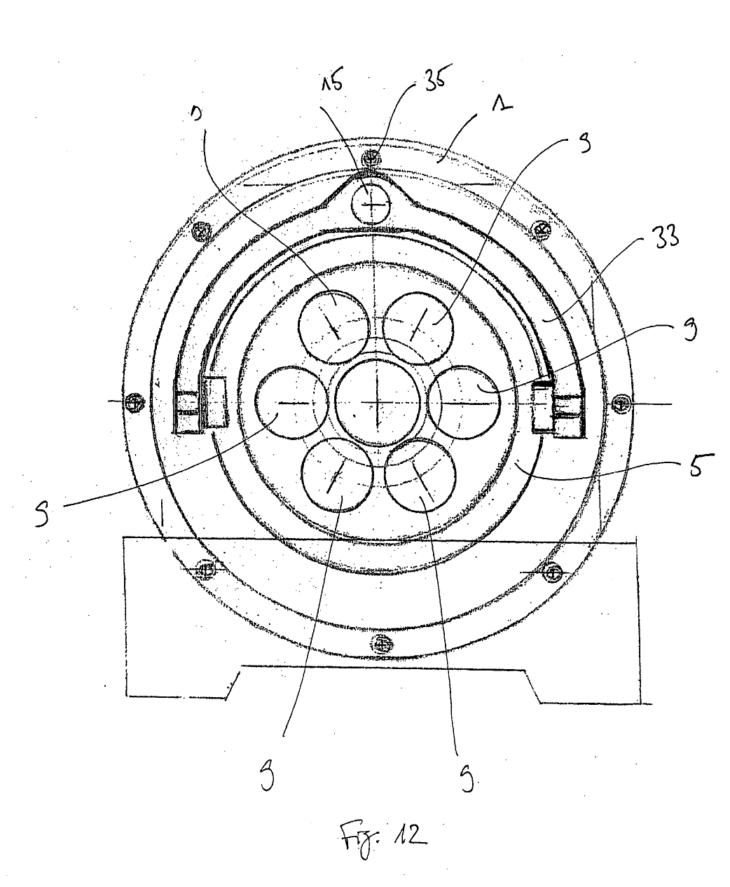

FIG. 12 shows a front view in partial cross section of the device assembled. The cylinder block 13, containing pistons 8 within the chambers 7, and around the block 13, the blocking ring and its actuating element 33, are located in the housing 1.

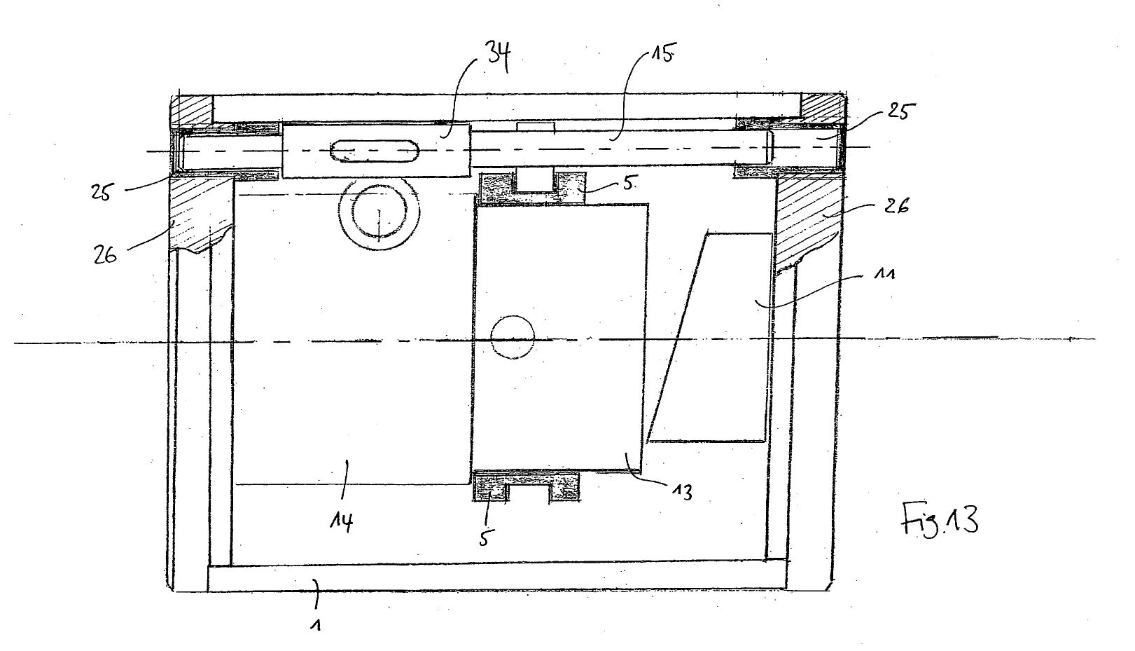

FIG. 13 shows a schematic side view in partial cross section of the control system of the variable speed drive. It comprises at least one handle support 15 with a socket 34 to which the control handle 2 is fixed. The support 15 is attached to the actuating element 33 which is itself inserted into the groove 31 of the ring 5 which allows the ring to be displaced over the cylinder block 13 and the orifices 6, 18 to be opened and closed.

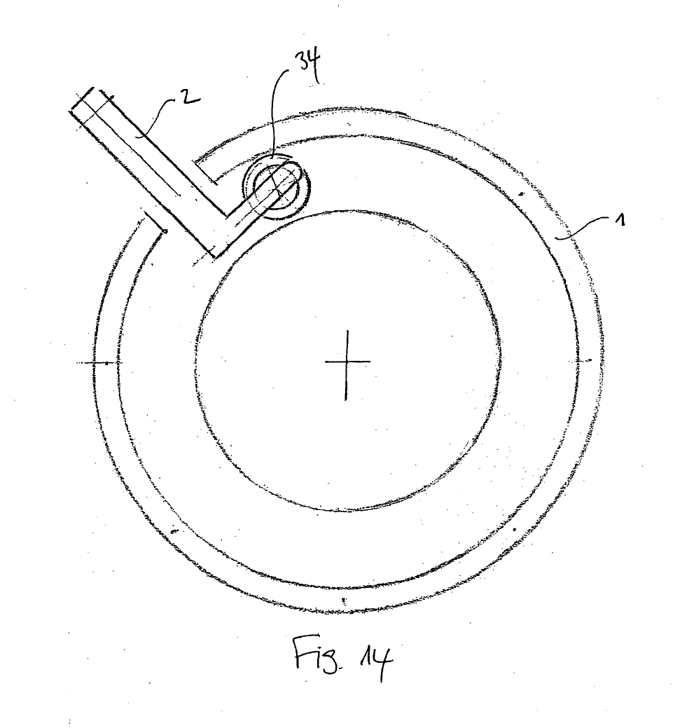

In FIG. 14, the control handle 2, which takes the form of an “L” and which engages into the handle support 15 (see FIGS. 2 and 13), is shown schematically.

FIGS. 15 to 24 are perspective views of the variable drive according to the first embodiment. In these views, the elements corresponding to the elements described hereinabove in relation to FIGS. 1 to 14 are identified with the same numerical references.

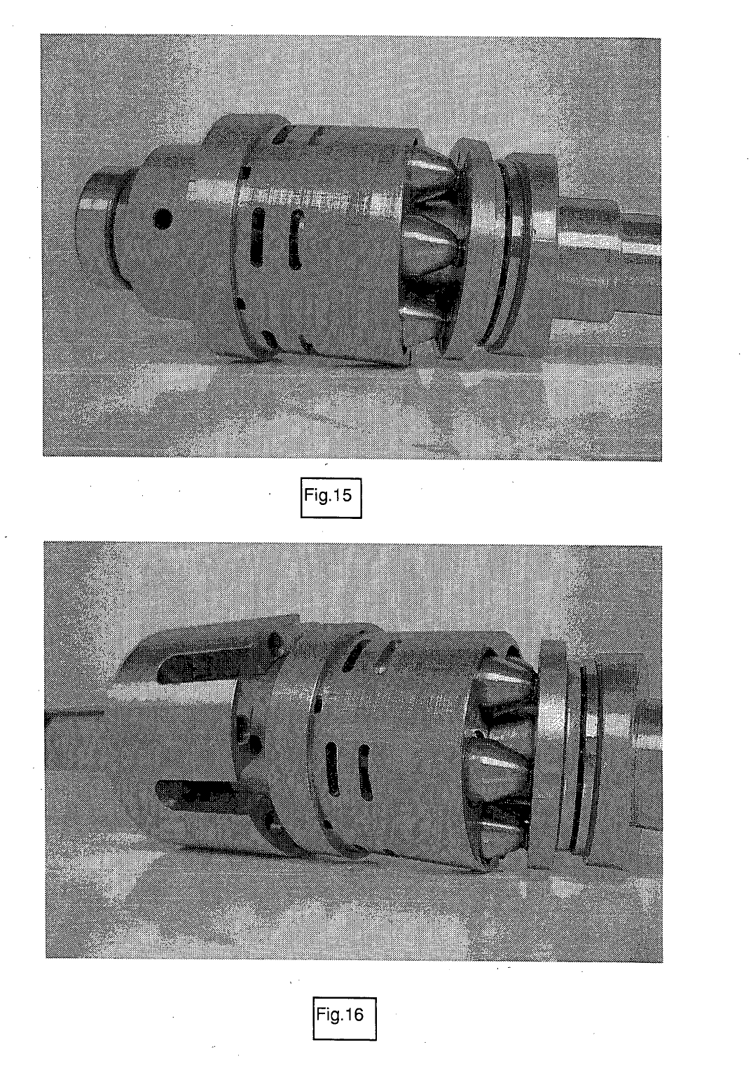

In FIGS. 15 and 16 notably, the blocking ring is not installed and the orifices allowing the passage of the fluid can clearly be seen. In the figure, the secondary axis and its end will be assembled onto the cylinder block 13.

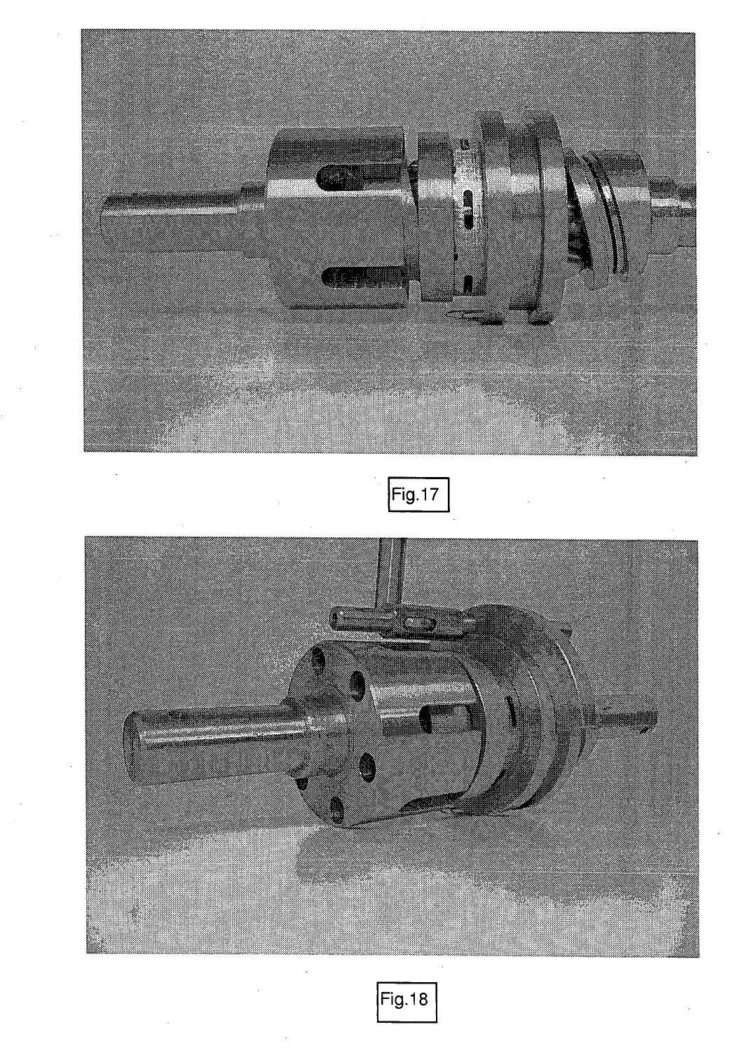

In FIG. 17, the blocking ring has been mounted onto the cylinder block and it blocks the orifices. Only the orifices corresponding to the orifices 6 are open. This would correspond to an intermediate position in between the fully open and the completely closed positions.

In FIG. 18, the means for controlling the position of the blocking ring, such as are described hereinabove, have been installed.

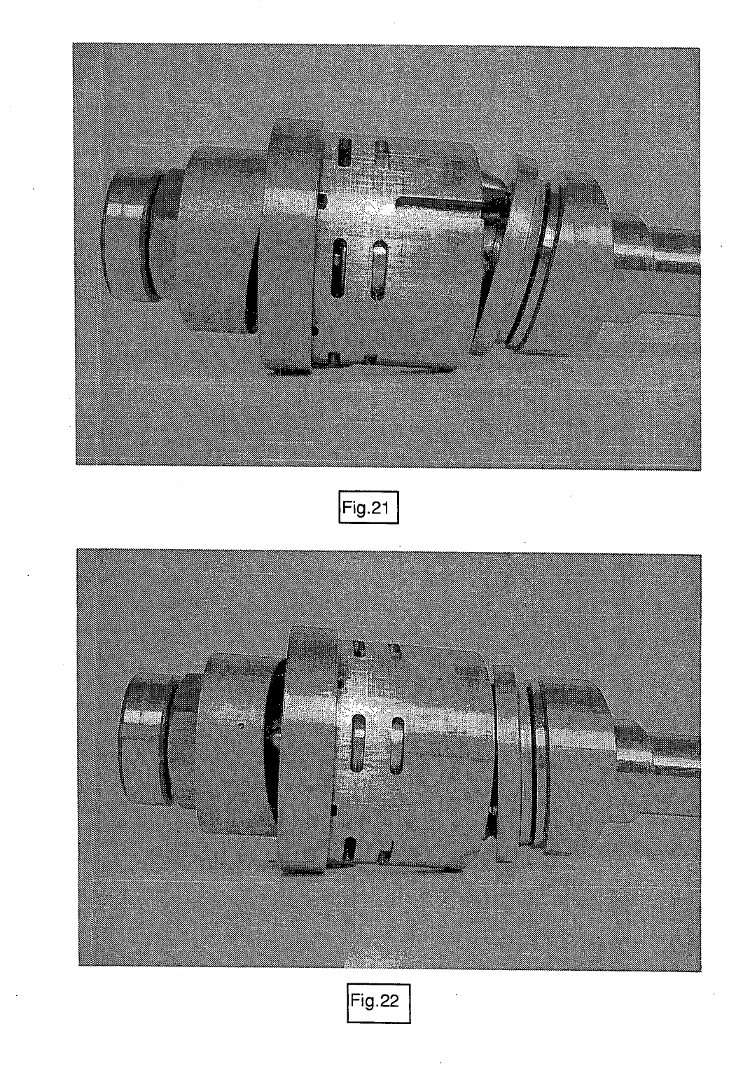

In the position in FIG. 20, the orifices corresponding to the orifices 6 are nearly completely closed by the blocking ring.

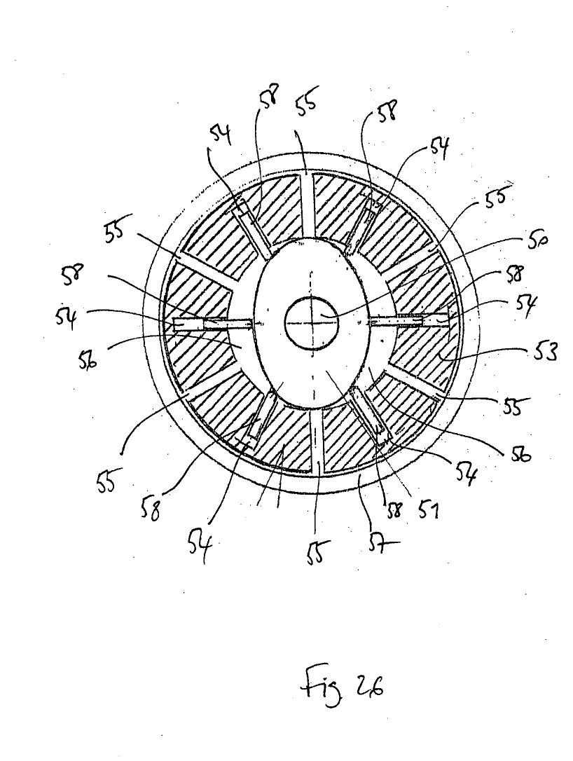

It goes without saying that the invention is not limited to the embodiment described hereinabove. Thus, by way of non-limiting examples, FIGS. 25 to 27 illustrate two other embodiments of the invention with one variant.

In FIG. 25, this second embodiment operates with a con-rod system. More precisely, in this system, the end of the primary axis 40 takes the form of a crankshaft 41, this being linked to pistons 42 on con-rods. The pistons move within the cylinders 43 each end of which comprises an opening 44. These openings 44 can be closed by a blocking ring 45 which is actuated by a handle 46. The blocking ring also comprises holes 47 designed to cooperate with the openings 44 in the cylinders 43 in order to provide the open position of the openings 44. The operation is similar to that of the first embodiment. When the holes 47 and openings 44 are lined up, the liquid can escape under the effect of the displacement of the pistons 42. Thus, the rotation of the primary axis 40 does not drive the secondary axis 47. In contrast, when the openings 44 are closed, the liquid can no longer escape from the cylinders 43 and the position of the pistons 42 is blocked. In this case, the rotational movement of the primary axis 40 drives the secondary axis at the same speed. In an intermediate position, the openings 44 are not completely closed and the pistons can move but not entirely freely, since the liquid offers a certain resistance to their movement. The effect of this is some slippage between the two axes and the secondary axis 47 will have a lower rotation speed than that of the primary axis 40.

One opening 44 per cylinder or several (for example two as shown in FIG. 3A) can be provided. They may take any shape, for example cylindrical, rectilinear or “banana”.

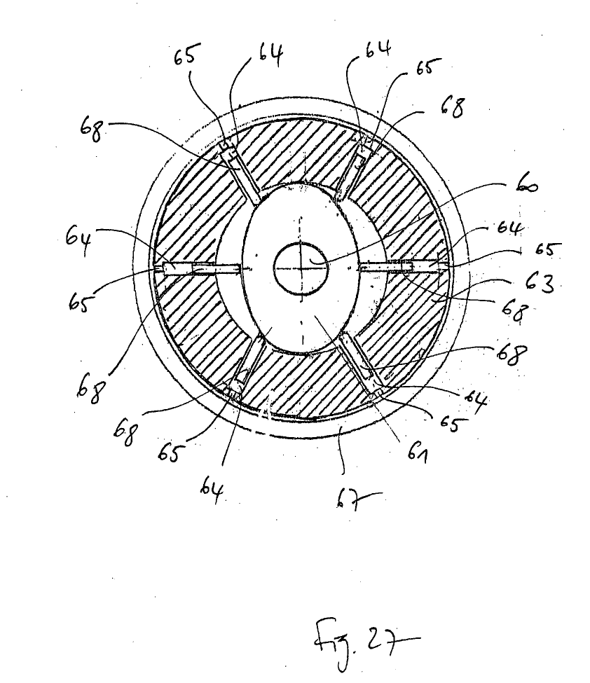

In FIG. 26, this third embodiment uses a shaft of elliptical shape. In this embodiment, the primary axis 50 has one end 51 whose profile is elliptical. The secondary axis 52 is fixed to a cylinder block 53 comprising a plurality of cylinders 54 distributed around the circumference. The block 53 also comprises a plurality of channels 55 allowing the passage of the liquid from the internal chambers 56 (situated between the end 51 and the inside of the block 53) to the external chamber (situated between the outside of the block 53 and the inside of the housing). A channel blocking ring 57 allows the channels 55 to be closed off. The pistons 58 are placed within the cylinders 54 and are connected by one of their ends to the end 51 of the primary axis 50, for example by a system similar to a cam. If the channels 55 are open, the liquid flows freely between the internal chamber 56 and the external chamber and the primary axis 50 rotates freely without driving the secondary axis 52 since no liquid impedes the movement of the pistons 58 within the cylinders 54. As soon as the channels 55 are closed, the movement of the pistons 58 is blocked and the secondary axis is driven in rotation by the primary axis 50. If the opening of the channels is in an intermediate position, the liquid will damp and slow the movement of the pistons 58: there will be slippage in the drive of the secondary axis 52 with respect to the primary axis 50 and the ratio will be less than 1, while still being non-zero, according to the principles of the present invention.

In the variant of the third embodiment shown in FIG. 27, the channels 55 have been eliminated and have been replaced by the channels 65 which are in the cylinders 54. More particularly, this variant comprises, like the third embodiment, a primary axis 60 with one end 61 whose profile is elliptical. The secondary axis 62 (not shown) is fixed to a cylinder block 63 comprising a plurality of cylinders 64 distributed around the circumference. The block 63 also comprises a plurality of channels 65 allowing the passage of the liquid from the cylinders 54 to the outside. A channel blocking ring 67 allows the channels 65 to be closed off. The pistons 68 are placed within the cylinders 64 and are connected by one of their ends to the end 61 of the primary axis 60, for example by a system similar to a cam. If the channels 65 are open, the liquid flows freely between the cylinder 64 and the outside and the primary axis 60 rotates freely without driving the secondary axis 62 since no liquid impedes the movement of the pistons 68 within the cylinders 64. As soon as the channels 65 are closed, the movement of the pistons 68 is blocked and the secondary axis is driven in rotation by the primary axis 60. If the opening of the channels 65 is in an intermediate position, the liquid will damp and slow the movement of pistons 68: there will be slippage in the drive of the secondary axis 62 with respect to the primary axis 60 and the ratio will be less than 1, while still being non-zero, according to the principles of the present invention. It goes without saying that, in this variant, a single channel 65 per cylinder 64 or more (for example two) can be provided.

In these embodiments, the same control (manual or assisted) can be used for displacing the blocking ring, such as is described hereinabove in relation to the first embodiment.

The number of pistons may be varied depending on the embodiment used and the intended application of the variable drive.

As indicated, the system of the invention can not only be used as a gearbox, but also as any element whose purpose is to transmit a rotational movement from a primary axis to a secondary axis, where it is desired to be able to vary the rotation speed ratios between the axes.

An eccentric configuration may also be imagined in which the primary and secondary axes are eccentric with respect to the axes in the variable drive. This solution can be obtained by adding means such as gears, where these can be used to change the rotation speed ratios between the axes.

The system according to the invention therefore offers a utility as reducer for any type of engines or motors (e.g. aviation, electric), self-blocking differential bridge, etc.

It may be used in many fields, as indicated hereinabove, in automobiles, aviation, boats, elevators, etc. Its use in toys may even be envisioned. In this case, it can be manufactured in plastic, if the constraints are not too severe, and the liquid could be water.

### NUMERICAL REFERENCES USED IN THE FIGURES

1. Housing
2. Handle
3. Primary axis
4. Secondary axis
5. Orifice blocking ring
6. Orifice for liquid
7. Cylinder chamber
8. Piston
9. First piston end
10. Second piston end
11. First inclined plane
12. Second inclined plane
13. Cylinder block
14. Secondary axis end
15. Handle support
16. Sump chamber
17. Orifice for end screws of the secondary axis
18. Orifice for liquid
19. Orifice for end screws of the cylinder block
20. Contact region primary axis-second inclined plane
21. Orifice
22. Orifice
23. Ball bearing
24. Plate
25. Openings
26. Flanges
27. Bearing
28. Openings
29. Ball bearing
30. Piston groove
31. Ring groove
32. Internal groove of the ring
33. Actuating element for the ring
34. Socket
35. Holes in the flange 26
36. Holes in the housing 1
40. Primary axis
41. Crankshaft
42. Pistons
43. Cylinders
44. Openings in the cylinders
45. Blocking ring
46. Handle
47. Holes in the blocking ring
48.
49.
50. Primary axis
51. End of the primary axis
52. Secondary axis
53. Cylinder block
54. Cylinders
55. Channels in the cylinder block
56. Internal chamber
57. Blocking ring
58. Pistons
59.
60. Primary axis
61. Primary axis end
62. Secondary axis
63. Cylinder block
64. Cylinders
65. Channels
66.
67. Blocking ring
68. Pistons

1. A variable speed drive between a primary axis having one end and a secondary axis, in which:
one end of the secondary axis is disposed in the extension of the end of the primary axis, said variable drive comprising
a block of cylinders disposed around the end of the primary axis, said block being rigidly attached to the secondary axis, each cylinder wall comprising at least one orifice connecting the inside of the cylinder with the outside,
an assembly of pistons disposed within said cylinders, said pistons being displaced by the end of the primary axis,
an annular element mounted in a sliding fashion around the block of cylinders in such a manner as to momentarily close off said orifices,
means for displacing said annular element along the block of cylinders in such a manner as to allow said orifices to be fully opened, or completely or partially closed off,
all the aforementioned elements being contained within a sump housing designed to contain a liquid and the opening of said orifices regulating the speed of rotation of the secondary axis with respect to the primary axis.

2. The variable speed drive as claimed in claim 1, in which the block comprises at least three cylinders with three pistons.

3. The variable speed drive as claimed in claim 1, in which each cylinder wall contains two orifices.

4. The variable speed drive as claimed in claim 1, in which the liquid is oil.

5. The variable speed drive as claimed in claim 1, in which the end of the primary axis comprises two parallel inclined planes disposed obliquely with respect to the main direction of the primary axis surrounding the pistons, said pistons being displaced by the rotation of said inclined planes and the stroke of the pistons being limited by said inclined planes.

6. The variable speed drive as claimed in claim 5, in which at least one of the inclined planes also comprises a bearing and a rotating plate parallel to said inclined plane.

7. The variable speed drive as claimed in claim 1, in which the end of the primary axis comprises a crankshaft for displacing the pistons via con-rods.

8. The variable speed drive as claimed in claim 1, in which the end of the primary axis has an elliptical shape.

9. The variable speed drive as claimed in claim 1, in which the means for displacing the annular element are manual means.

10. The variable speed drive as claimed in claim 1, in which the means for displacing the annular element are assisted by an electric or electronic control via an actuator.
